(19) United States
(12) Patent Application Publication
(10) Pub. No.: US 2012/0162513 A1
(43) Pub. Date: Jun. 28, 2012

(54) DUAL-CONNECTION MULTIMEDIA APPARATUS

(76) Inventors: TSE-MING CHANG, Taipei (TW); Chung-Hao Wu, Taipei (TW)

(21) Appl. No.: 13/326,883

(22) Filed: Dec. 15, 2011

(30) Foreign Application Priority Data
Dec. 28, 2010 (TW) 099225268

(51) Int. Cl. H04N 7/00; G06F 3/00

(52) U.S. Cl. 348/552; 715/716; 348/E07.001

(57) ABSTRACT

The invention relates to a multimedia apparatus and more particularly to a multimedia apparatus capable of providing karaoke service through Internet servers or other external devices. The invention provides operating interfaces that are compatible to individual hardware, internet server, and mode of instruction input. The invention identifies multimedia files in external storages and further offers an offline karaoke service.

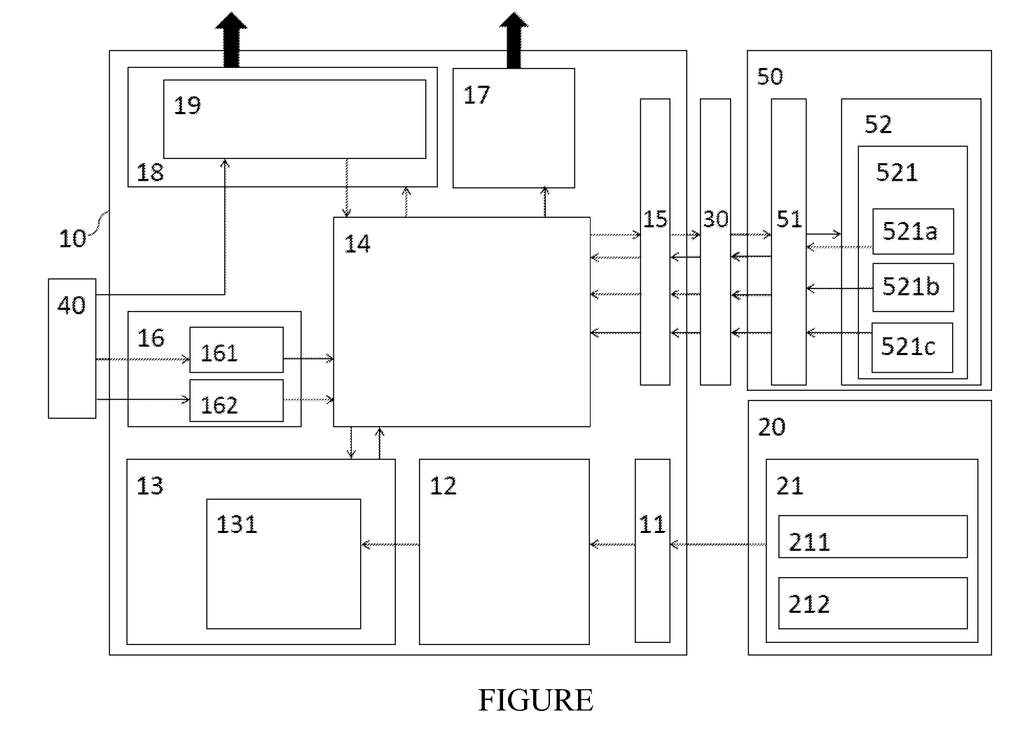

### FIELD OF THE INVENTION

The invention relates to a multimedia apparatus and more particularly to a multimedia apparatus capable of providing karaoke service through Internet servers or other external devices.

### BACKGROUND OF THE INVENTION

Online karaoke services and apparatuses currently on the market are normally realized via designated Multimedia on Demand (MOD) service providers, or via specific websites. However, the above mentioned online karaoke services and apparatuses do not provide operating interfaces that are completely compatible to individual hardware, internet server, and mode of instruction input. This phenomenon causes users of different internet servers unable to enjoy the same online karaoke service with different operating interfaces, and therefore limits the number of prospective users and the opportunities of using the interactive device.

The early technology of the online karaoke services and apparatuses mentioned above can only offer users the functions like online request, download, and play songs, but fails to identify the media files in the external storage and offer an offline karaoke service. At their most, they simply display and play the existing files. As for those devices which fail to provide a song-request mode similar to that of a karaoke machine, the users tend to find it inconvenient to search for files and play songs.

### BRIEF DESCRIPTION OF THE DRAWINGS

The FIGURE shows a block diagram of an embodiment of the claimed invention.

### DETAILED DESCRIPTION OF THE INVENTION

The FIGURE shows one embodiment of the dual-connection multimedia apparatus 10 of the claimed invention. The dual-connection multimedia apparatus 10 includes a docking unit 11, a recognition unit 12, a storage unit 13, a processing unit 14, a connecting unit 15, an input unit 16, an audio output unit 17, a video output unit 18, and a user interface 19. The docking unit 11 connects to an external device 20. The recognition unit 12 connects to the docking unit11. The external device 20 comprises a multimedia file 21 which is transferred to the recognition unit 12 via the docking unit 11, so that the recognition unit 12 recognizes the multimedia file 21. A storage unit 13 connects to the recognition unit 12. The recognition unit 12 recognizes the multimedia file 21 and generates a sorting information 131, the sorting information 131 is transferred to the storage unit 13. A processing unit 14 connects to the storage unit 13. The processing unit 14 accesses the sorting information 131 stored in the storage unit 13. A connecting unit 15 connects to the processing unit 14 and the Internet 30 service. The connecting unit 15 receives a song information 521 via the Internet 30 service and transfers the song information 521 to the processing unit 14. An audio output unit 17 connects to the processing unit 14. A video output unit 18 connects to the processing unit 14, wherein the processing unit 14 merges and processes the song information 521 with an audio input 161 or a video information 521a, and the processed information can be exported by the audio output unit 17 or the video output unit 18. A user interface19 shown on the video output unit 18, wherein the user 40 can operate the user interface 19 and give instructions to the processing unit 14, in order to carry out dual-connection karaoke service. An input unit 16 connects to the processing unit 14, wherein an audio input 161 and an video input 162 are imported to the processing unit 14 via the input unit 16 according to the instructions received from the user interface.

In one embodiment, the user interface 19 displayed on the video output unit 18 receives instructions indicative of the at least one multimedia file 21 transmitted from the external device 20 via the docking unit 11 or from the at least one multimedia server 50. The input unit 16 receives the audio input 161 and the video input 162 from the user 40. The recognition unit 12 recognizes the at least one multimedia file 21 and generates the song information 521 and stores the song information 521 on the storage unit 13. The processing unit 14 merges the song information 521 with the audio input 161 and outputs to the audio output unit 17, and the processing unit 14 merges the song information 521 with the video input 162 and outputs to the video output unit 18.

The recognition unit 12 recognizes an identification code 211 and a tag information 212 of the multimedia file 21 to generate the sorting information 131. The user interface19 accesses the storage unit 13 via the processing unit 14 in order to process song request. The external device 20 refers to portable Universal Serial Bus, CD-ROM, DVD-ROM, digital camera, digital video recorder, or other storage devices.

The connecting unit 15 can be connected to a multimedia server 50 via the Internet 30 service. The multimedia server 50 may be one or more web server groups 51. The multimedia server 50 provides karaoke services includes song streaming, broadcasting, replay of recorded audios , replay of recorded videos , multimedia file uploading, and personal multimedia blog to the dual-connection multimedia apparatus 10 via the Internet 30 service.

The multimedia server 50 further includes a song database 52; the song database 52 stores the song information 521 which comprises a video information 521a, a music information 521b, a subtitle for lyric information 521c, and the combination thereof; the multimedia server 50 can also send designated the song information 521 to the processing unit 14 via the Internet 30 service according to the instructions given by the user interface19.

Regarding the song information 521 transferred to the processing unit 14, when the user 40 operates the user interface 19, the user 40 can choose to combine only the music information 52 lb and the subtitle information 521c, whereas the video input 162 and the subtitle information 521c can be processed via the processing unit 14 before being exported by the video output unit 18, while the video input 162 can be imported by the input unit 16.

The song information 521 transferred to the processing unit 14, when the user 40 operates the user interface19, the user can choose to combine only the music information 521b and the video information 521a. After the multimedia server 50 detects the import of the video input 162 into the input unit 16 via the web server groups 51, the multimedia server 50 will automatically allow the song information 521 to include only the combination of the music information 521b and the subtitle information 521c, so that the video input 162 and the subtitle information 521c can be processed by the processing unit 14 and be exported along the combination of the music information 521b and the subtitle information 521c via the video output unit 18.

The user interface19 provides different layouts according to the size of the video output unit 18, picture size, hardware, and Internet bandwidth. The user interface19 provides song request services based on the information or categories such as performer's name, Chinese phonetic symbols, stroke-count, song title word-count, Pin-Yin, situational status, billboard ranking, latest updates, USB recorded songs, audio command, children's songs, English songs, and Japanese songs.

The dual-connection multimedia apparatus 10 includes connected TV, regular TV with set-top-box, personal computer (PC), tablet personal computer (tablet PC), iPhone, iPod, iPad, smart phone, digital frame with Internet access, or handheld devices with Internet access. The audio output unit 17, the video output unit 18, and the input unit 16 can be either built-in or externally connected to the dual-connection multimedia apparatus. The audio output unit 17, the video output unit 18, and the input unit 16 can be externally connected to the dual-connection multimedia apparatus 10 with or without wire.

Several descriptions and illustrations have been provided to aid in understanding the claimed invention. One skilled in the art will realize that numerous changes and variations are possible without departing from the spirit of the invention. Each of these changes and variations is within the scope of the present invention.

What is claimed is:

1. A dual-connection multimedia apparatus comprising:
an user interface displayed on an video output unit to receive instructions indicative of at least one multimedia file transmitted from an external device via a docking unit or from at least one multimedia server;
an input unit receiving audio input and video input from an user;
a recognition unit recognizing the at least one multimedia file to generate a song information and storing the song information on a storage unit; and
a processing unit merging the song information with the audio input, and outputting the merged song information to the audio output unit or the video output unit in accordance with the user instructions received from the user interface.

2. The dual-connection multimedia apparatus of claim 1, wherein the recognition unit recognizes an identification code and a tag information of the at least one multimedia file to generate sorting information.

3. The dual-connection multimedia apparatus of claim 1, wherein the instructions indicative of the multimedia file are song requests from the users.

4. The dual-connection multimedia apparatus of claim 1, wherein the external device comprises portable Universal Serial Buses, Compact Discs-Read-Only-Memory (CD-ROMs), Digital Video Discs- Read-Only-Memory (DVD-ROMs), digital cameras, digital video recorders, or other memory devices.

5. The dual-connection multimedia apparatus of claim 1, wherein the at least one multimedia server provides karaoke services comprising song streaming, broadcasting, replay of recorded audios, replay of recorded videos , multimedia file uploading and personal multimedia blog.

6. The dual-connection multimedia apparatus of claim 5, wherein the at least one multimedia server further comprises a song database storing the song information, the song information comprises a video information, a music information, a subtitle information, and the at least one multimedia server transmits the selected multimedia file to the processing unit upon receiving the instructions from the user interface.

7. The dual-connection multimedia apparatus of claim 6, wherein the processing unit merges the audio input or the video input with the song information upon detecting the audio input or the video input captured from the input unit

8. The dual-connection multimedia apparatus of claim 1, wherein a dimension of the user interface is dynamically adjusted according to a dimension of the video output unit.

9. The dual-connection multimedia apparatus of claim 1, wherein the dual-connection multimedia apparatus includes a connected television (TV), or a regular TV coupled with a set-top box.

10. The dual-connection multimedia apparatus of claim 1, wherein the external device includes personal computer, tablet personal computer, iPhone, iPad, iPod, smart phone, digital frame with Internet access, or portable devices with Internet access.

11. The dual-connection multimedia apparatus of claim 1, wherein the audio output unit, the video output unit, and the input unit may be built-in or externally connected to the dual-connection multimedia apparatus.
